(19) United States
(12) Patent Application Publication
(10) Pub. No.: US 2004/0152065 A1
(43) Pub. Date: Aug. 5, 2004

(54) Diagnostic demonstration devices and methods

(75) Inventor: Daniel D. Witkowski, Minneapolis, MN (US)

Correspondence Address: MUETING, RAASCH & GEBHARDT, P.A., P.O. BOX 581415, MINNEAPOLIS, MN, 55458, US

(73) Assignee: MagicCom, Minneapolis, MN

(21) Appl. No.: 10/714,545

(22) Filed: Nov. 14, 2003

Related U.S. Application Data
(60) Provisional application No. 60/426,301, filed on Nov. 14, 2002.

(51) Int. Cl. G09B 23/28; G09B 25/00

(52) U.S. Cl. 434/365; 434/262

(57) ABSTRACT

Diagnostic demonstration devices and methods are disclosed that, in various embodiments, may include a simulated test strip and a mechanism capable of extending the simulated test strip out of the housing and retracting the simulated test strip into the housing. In other embodiments, a simulated test strip supply and a mechanism operably attached to the simulated test strip supply are provided with the mechanism capable of dispensing a simulated test strip from the simulated test strip supply. The diagnostic demonstration devices may not include functional diagnostic hardware designed to analyze a biological tissue or fluid sample obtained from a patient.

### RELATED APPLICATION

The present application claims the benefit under 35 U.S.C. § 119 of U.S. Provisional Patent Application No. 60/426,301, titled DIAGNOSTIC DEMONSTRATION DEVICE and filed on Nov. 14, 2002, which is hereby incorporated by reference in its entirety.

### BACKGROUND

Companies that manufacture various consumer products often have to rely on advertising or packaging to communicate the features and benefits of their product to resellers or end users. Without the ability to see, touch and/or hold a product, a two-dimensional communication such as a package, brochure, and the like does not provide a manufacture or marketer the opportunity to demonstrate the product features first hand.

An alternative is to provide actual samples of real working products for resellers or consumers to test for themselves, but this can prove to be extremely costly, and may present other issues such as theft of display models, potential harm certain products can inflict during a demonstration upon children or adults, breakage, misuse and the like.

An example of a category that could benefit from a product demonstration would be consumer products, appliances and medical products. This category may include blood pressure monitors, nebulizers, temperature measurement devices, diagnostic testing devices, and the like. Often these devices have complex and costly internal parts which most resellers and end users do not understand. What is generally important to end-users is the ease of use of the product, cost and sometimes elements such as size, weight and the like.

Since it is generally cost prohibitive to supply demonstration sample units to distributors, doctors, insurance companies, resellers, and consumers the product marketers generally have to rely on more traditional means to communicate the features and benefits of the product.

### SUMMARY OF THE INVENTION

The present invention provides diagnostic demonstration devices and methods that, in various embodiments, may include a simulated test strip and a mechanism capable of extending the simulated test strip out of the housing and retracting the simulated test strip into the housing. In other embodiments, the present invention provides a simulated test strip supply and a mechanism operably attached to the simulated test strip supply, the mechanism capable of extending a simulated test strip from the simulated test strip supply out of the housing.

The diagnostic demonstration devices of the present invention provide marketing channels with the opportunity to use a fully articulated simulator to demonstrate a product without the need for the complex actual inner workings of a fully functional product such as a diagnostic-testing meter. In the instance of, e.g., a diabetes-testing meter, such a diagnostic demonstration device may have numerous advantages over a fully functional model. While such a device may mirror the visual design trade dress, size, weight, and other visual characteristics of its fully functional counterpart, it would not need all of the internal functional diagnostic components that add to the overall cost.

Such a simulator could demonstrate features such as, e.g., the push button simplicity of dispensing a test strip used to analyze blood glucose level. However, unlike a fully functioning meter which ejects or releases a test strip for disposal after actual use, the diagnostic demonstration devices of the present invention could be programmed to retract a simulated test strip after a designated amount of time, thus saving the need to reload and waste strips for demonstration purposes. This retraction could also minimize the common problem of causing test strips to jam in the device, which would not represent the fully functional unit in a favorable light.

In other embodiments, the diagnostic demonstration devices of the present invention could dispense simulated test strips from a supply located within the device. The supply of simulated test strips may be provided in the form of, e.g., a cartridge, magazine, drum, etc. Furthermore, the supply could include individual simulated test strips or it could include, e.g., a roll, drum or other continuous supply that could require a user to separate a strip from the unit.

The potential advantages of devices that are designed to dispense simulated test strips include, e.g., accurate simulation of how a device may dispense an actual functional test strip, the ability to provide a marketing message on the simulated test strip, etc.

Another potential advantage of a diagnostic demonstration device over a functional diagnostic device is that the demonstration device may be used on a display in a store, pharmacy, physician's office, etc. Such a display provide the opportunity for an end user to become comfortable using a diagnostic device by allowing them to try, first hand, the push button simplicity and ease of operation of the diagnostic demonstration devices.

Another version of a display bracket may also allow consumers to see the action of dispensing a diagnostic strip, yet protecting the device from vandalism and/or theft by means of encasing the unit or portion thereof in a protective case or bubble. This could attach to a display, counter shelf or the like.

Another advantage of making end users comfortable with the process of utilizing a device such as a meter, tester, appliance, or simulator is the potential to introduce a audio device that will allow the device to “talk” to users to describe the steps of operation. Such audio capabilities may also assist elderly or visually impaired consumers through the process of using a diagnostic device. Another feature may be using lights or other visual mechanisms other than LED diodes to assist end users in the diagnostic process.

Another embodiment of the invention would allow the simulator to function as a display unit by utilizing a sensor or a repeat timing device to allow it to perform in a demonstration mode automatically or when it senses motion.

In one aspect, the present invention provides a diagnostic demonstration device including a housing defining a housing volume; a simulated test strip; and a mechanism located within the housing, the mechanism operably attached to the simulated test strip, the mechanism capable of extending the simulated test strip out of the housing and retracting the simulated test strip into the housing.

In another aspect, the present invention provides a diagnostic demonstration device including a housing defining a housing volume free of diagnostic testing hardware; display indicia on the housing mimicking a digital display; a simulated test strip; a mechanism located within the housing, the mechanism operably attached to the simulated test strip, the mechanism capable of extending the simulated test strip out of the housing and retracting the simulated test strip into the housing; an actuator on the housing operably connected to the mechanism, wherein actuation of the actuator causes the mechanism to extend the simulated test strip out of the housing; and a timer operably connected to the mechanism, wherein the timer causes the mechanism to retract the simulated test strip into the housing after a designated amount of time.

In another aspect, the present invention provides a diagnostic demonstration device including a housing defining a housing volume; a simulated test strip supply located within the housing volume; and a mechanism located within the housing, the mechanism operably attached to the simulated test strip supply, the mechanism capable of extending a simulated test strip from the simulated test strip supply out of the housing.

In another aspect, the present invention provides a method of demonstrating a diagnostic device by providing a diagnostic demonstration device including a housing defining a housing volume, only a single simulated test strip associated with the diagnostic demonstration device, and a mechanism located within the housing, the mechanism operably attached to the simulated test strip; extending the simulated test strip out of the housing using the mechanism; and retracting the simulated test strip into the housing.

In another aspect, the present invention provides a method of demonstrating a diagnostic demonstration device by providing a diagnostic demonstration device including a housing defining a housing volume, a simulated test strip supply, and a mechanism located within the housing, the mechanism operably attached to the simulated test strip supply; and dispensing a simulated test strip from the simulated test strip supply out of the housing using the mechanism.

These and other features and advantages may be described below in connection with one or more illustrative embodiments of the invention.

### BREIF DESCRIPTION OF THE DRAWINGS

FIG. 1 is a perspective view of one diagnostic demonstration device according to the present invention.

FIG. 2 is a block diagram of components within one diagnostic demonstration device including a reciprocating simulated test strip according to the present invention.

FIG. 3 is a block diagram of components within one diagnostic demonstration device including a simulated test strip supply from which simulated test strips are dispensed according to the present invention.

### DETAILED DESCRIPTION OF ILLUSTRATIVE EMBODIMENTS OF THE INVENTION

In the following detailed description of illustrative embodiments, reference is made to the accompanying drawings that form a part hereof, and in which are shown, by way of illustration, specific embodiments in which the invention may be practiced. It is to be understood that other embodiments may be utilized and structural changes may be made without departing from the scope of the present invention. Furthermore, like reference numbers denote like features in the different figures.

FIG. 1 is a perspective view of one diagnostic demonstration device 10 according to the present invention. The diagnostic demonstration devices of the present invention may be modeled after any suitable medical or biological diagnostic device. It may be preferred that the diagnostic demonstration devices be modeled after medical or biological diagnostic devices designed for use by a patient, such as blood glucose monitors, etc. For example, the diagnostic demonstration devices of the present invention may be modeled after one or more of the functional diagnostic devices marketed by Roche Diagnostics Corporation (under the tradename ACCU-CHEK), Lifescan, Inc. (under the tradename ONETOUCH ULTRASMART), Polymer Technology Systems, Inc. (under the tradename CARDIOCHEK P·A), etc.

The device 10 includes a housing 12 that defines an interior housing volume. Unlike a functional diagnostic device, the device 10 preferably does not contain any functional diagnostic hardware such as, e.g., sensors, circuitry, etc. designed to analyze a biological tissue or fluid sample obtained from a patient. As a result, the diagnostic demonstration device 10 cannot function as an actual diagnostic device. Rather, the device 10 preferably includes a mechanism adapted to control the movement of one or more simulated test strips 20 as described in more detail below.

The depicted device 10 may also preferably include a simulated test strip 20 that, in various configurations, extends out of the housing 12 of the device 10. In some embodiments, the simulated test strip 20 can also be retracted into the housing 12 of the device 10. As used herein, a “simulated test strip” includes a test strip that is not suitable for use in a functional diagnostic device, e.g., a test strip that does not include any suitable reagents. A simulated test strip may also include, for example, a functional test strip (e.g., with reagents) that has been rendered un-usable by virtue of, e.g., long-term exposure or potential contamination such as might be experienced if the diagnostic demonstration device were used to demonstrate the device to potential customers who may, for example, handle the test strip, etc.

The device 10 may also preferably include display indicia 14 on the housing 12 that mimics an actual digital display that may be found on, e.g., a functional diagnostic demonstration device. The display indicia 14 may mimic, e.g., an LCD or LED display. It may take the form of an adhesive label applied to the housing 12, paint, ink, etc.

In some embodiments, an actual working digital display could be included in the device 10 if so desired. Such a display could mimic the displays found on a functional diagnostic demonstration device and/or it could provide a marketing message to a user. In addition, a working display may also include indicia or messages informing the user that the diagnostic demonstration device 10 is not a functional diagnostic device.

The device 10 may also include an optional actuator 16 such as a push button, switch, touch pad, etc. that may be operatively connected to the mechanism used to control movement and/or dispensing of any simulated test strips associated with the device 10.

The actuator 16 may alternatively include or be provided in the form of a proximity sensor capable of detecting movement or the presence of an individual such that the simulated test strip mechanism may be activated without requiring an individual to manually activate the actuator 16. Such sensors may operate using, e.g., ultrasonic energy, infrared energy, etc.

Another optional feature that may be provided in connection with diagnostic demonstration devices according to the present invention is the use of indicia 18 on the housing 12 that provides a message to the user that the diagnostic demonstration is not a functional diagnostic test unit.

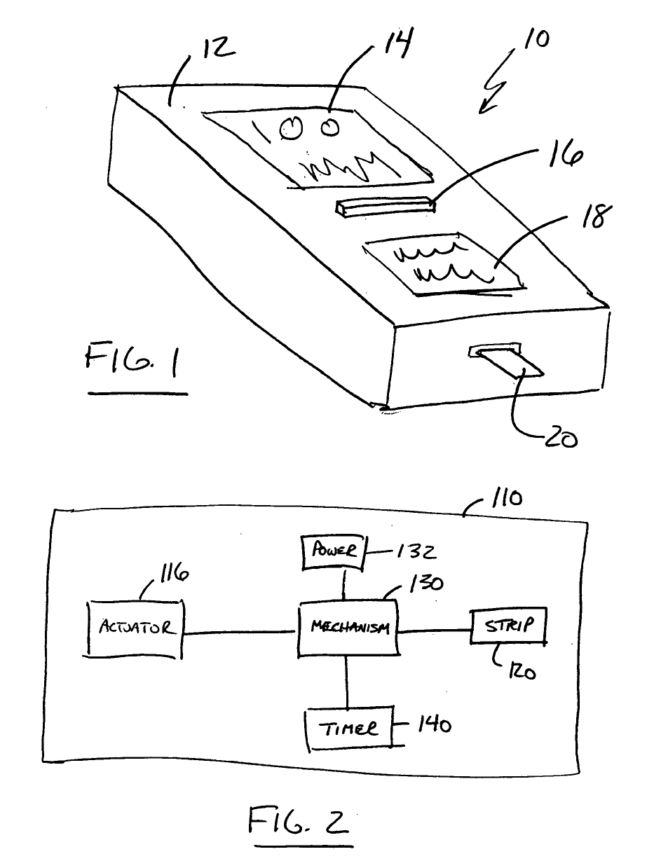

Turning to FIG. 2, a block diagram of one diagnostic demonstration device according to the present invention is depicted in which a simulated test strip can be extended from and retracted into the housing of the device 110. The device 110 includes an actuator 116 operatively connected to a mechanism 130 used to extend and retract the simulated test strip 120. The depicted device also includes a power source 132 and a timer 140 that are both operatively connected to the mechanism 130.

The optional actuator 116 may take a variety of forms, e.g., a push button, touch pad, etc. that requires manual action from a user. Alternatively, the actuator may take the form of, e.g., a sensor arranged to detect the presence of a potential user and actuate the device 110 to, e.g., extend the simulated test strip 120. Such sensors may be described in, e.g., U.S. Pat. No. 5,097,981 (Degasperi et al.). The actuation may also be used to activate sound and/or light components (not shown) on the device 110 to attract the attention of a potential user.

The power source 132 may take any suitable form dependent in large part on the power needs of the mechanism 130. The power source 132 may be self-contained within the unit, e.g., a battery, solar cell, wind-up spring, etc. In other embodiments, the power source may be line voltage (e.g., 120 volt AC) such that the device 110 must be located near a power outlet. Further, the devices 110 may include dual mode power sources, e.g., a solar cell and a battery, etc.

The timer 140 may be useful in operation of the device 110 as follows. The simulated test strip 120 is designed to be extended from the device 110 to provide a user with a simulated diagnostic test procedure. The simulated test strip 120 may be so extended in response to actuation of the mechanism 130 by actuator 116. The timer 140 may be used to cause the mechanism 130 to retract the simulated test strip 120 into the device 110 after a designated time period. In some embodiments, the timer 140 may also be used to cause the mechanism 130 to extend the simulated test strip 120 after a designated period of time.

The mechanism 130 used to extend and retract the simulated test strip 120 may take any number of suitable forms, e.g., a motor and pinch rollers for moving the simulated test strip 120, a solenoid device capable of extending and retracting the simulated test strip 120, a motor and wind-up device capable of winding and unwinding the test strip 120, a spring-loaded mechanism if the simulated test strip 120, etc. Examples of some suitable mechanisms that could be easily modified to provide the desired reciprocating action to the simulated test strip 120 may be found in, e.g., U.S. Pat. Nos. 5,097,981 (Degasperi et al.); 5,207,349 (Kringel); and 5,249,705 (Gates).

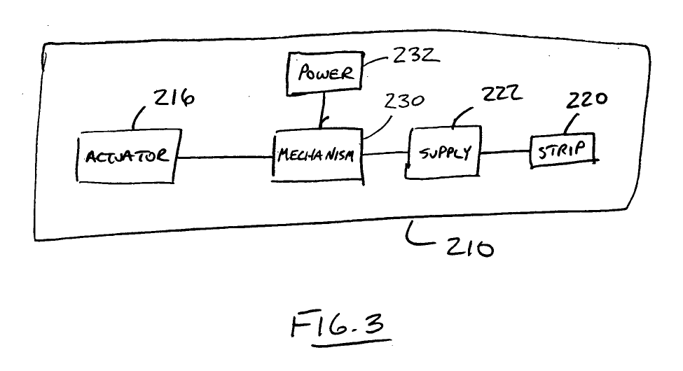

FIG. 3 is a block diagram of another embodiment of a diagnostic demonstration device 210 according to the present invention. The device 210 includes an optional actuator 216 operatively connected to the mechanism 230 for manipulating the simulated test strip 220 from a supply 222 of simulated test strips contained within the device 210. A power supply 232 is also depicted in FIG. 3 as being operatively connected to the mechanism 230. The device 210 may include a timer as described above in connection with FIG. 2.

In operation, the device 210 may be used to dispense simulated test strips 220 from supply 222. Unlike the embodiment of FIG. 2, this embodiment of the device 210 may be designed to allow a user to remove the test strip 220 from the device 210, such that the device 210 acts as a dispenser of simulated test strips 220.

The supply 222 of simulated test strips 220 may take a variety of forms, e.g., a cartridge, tray, drum, etc. of separate, individual simulated test strips 220. In other embodiments, the supply 222 may include simulated test strips 220 in a continuous supply, e.g. a roll. If the simulated test strips 220 are provided in a roll form, the roll may include score lines at the boundaries of each simulated test strip 220 to facilitate separation from the roll. Alternatively, the device 210 may be designed to allow the user to tear off a simulated test strip using, e.g., a blade or other cutting mechanism supplied on the device 210.

As with the device 110 described above with respect to FIG. 2, the device 210 of FIG. 3 may be manufactured using a mechanism 230 and other components and principles as described in, e.g., U.S. Pat. Nos. 5,097,981 (Degasperi et al.); 5,207,349 (Kringel); and 5,249,705 (Gates). Unlike the mechanism 130 described above with respect to FIG. 2, the mechanism 230 may not be capable of retracting a simulated test strip 120 after it has been removed from the supply 222.

All references and publications cited herein are expressly incorporated herein by reference in their entirety. Illustrative embodiments of this invention are discussed and reference has been made to some of the possible variations within the scope of this invention. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

1. A diagnostic demonstration device comprising:
a housing defining a housing volume;
a simulated test strip; and
a mechanism located within the housing, the mechanism operably attached to the simulated test strip, the mechanism capable of extending the simulated test strip out of the housing and retracting the simulated test strip into the housing.

2. A device according to claim 1, further comprising display indicia on the housing mimicking a digital display.

3. A device according to claim 1, further comprising an actuator on the housing operably connected to the mechanism, wherein actuation of the actuator causes the mechanism to retract the simulated test strip into the housing.

4. A device according to claim 1, further comprising an actuator on the housing operably connected to the mechanism, wherein actuation of the actuator causes the mechanism to extend the simulated test strip out of the housing.

5. A device according to claim 1, comprising a timer operably connected to the mechanism, wherein the timer causes the mechanism to retract the simulated test strip into the housing after a designated amount of time.

6. A device according to claim 1, wherein the housing is free of functional diagnostic hardware designed to analyze a biological tissue or fluid sample obtained from a patient.

7. A device according to claim 1, further comprising indicia on the housing indicating that the device is not a functional diagnostic test unit.

8. A diagnostic demonstration device comprising:
a housing defining a housing volume free of diagnostic testing hardware;
display indicia on the housing mimicking a digital display;
a simulated test strip;
a mechanism located within the housing, the mechanism operably attached to the simulated test strip, the mechanism capable of extending the simulated test strip out of the housing and retracting the simulated test strip into the housing;
an actuator on the housing operably connected to the mechanism, wherein actuation of the actuator causes the mechanism to extend the simulated test strip out of the housing; and
a timer operably connected to the mechanism, wherein the timer causes the mechanism to retract the simulated test strip into the housing after a designated amount of time.

9. A diagnostic demonstration device comprising:
a housing defining a housing volume;
a simulated test strip supply located within the housing volume; and
a mechanism located within the housing, the mechanism operably attached to the simulated test strip supply, the mechanism capable of extending a simulated test strip from the simulated test strip supply out of the housing.

10. A device according to claim 9, further comprising display indicia on the housing mimicking a digital display.

11. A device according to claim 9, further comprising an actuator on the housing operably connected to the mechanism, wherein actuation of the actuator causes the mechanism to extend the simulated test strip out of the housing.

12. A device according to claim 9, comprising a timer operably connected to the mechanism, wherein the timer causes the mechanism to retract the simulated test strip into the housing after a designated amount of time.

13. A device according to claim 9, wherein the housing is free of functional diagnostic hardware designed to analyze a biological tissue or fluid sample obtained from a patient.

14. A device according to claim 9, wherein simulated test strip supply comprises a plurality of separate, individual simulated test strips.

15. A device according to claim 9, wherein the simulated test strip supply comprises a continuous roll.

16. A device according to claim 9, further comprising indicia on the housing indicating that the device is not a functional diagnostic test unit.

17. A method of demonstrating a diagnostic device, the method comprising:
providing a diagnostic demonstration device comprising a housing defining a housing volume, only a single simulated test strip associated with the diagnostic demonstration device, and a mechanism located within the housing, the mechanism operably attached to the simulated test strip;
extending the simulated test strip out of the housing using the mechanism; and
retracting the simulated test strip into the housing.

18. A method according to claim 17, wherein the housing is free of functional diagnostic hardware designed to analyze a biological tissue or fluid sample obtained from a patient.

19. A method of demonstrating a diagnostic demonstration device, the method comprising:
providing a diagnostic demonstration device comprising a housing defining a housing volume, a simulated test strip supply, and a mechanism located within the housing, the mechanism operably attached to the simulated test strip supply; and
dispensing a simulated test strip from the simulated test strip supply out of the housing using the mechanism.

20. A method according to claim 19, wherein mechanism is not capable of retracting the simulated test strip after dispensing the simulated test strip.
